(19) United States
(12) Patent Application Publication
(10) Pub. No.: US 2006/0237479 A1
(43) Pub. Date: Oct. 26, 2006

(54) POST-MIX BEVERAGE DISPENSER FOR CREATING FROTHED BEVERAGES

(76) Inventor: David Fox, Sylmar, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/426,533

(22) Filed: Jun. 26, 2006

Related U.S. Application Data
(63) Continuation-in-part of application No. 11/004,466, filed on Dec. 3, 2004, now Pat. No. 7,070,068.
Application No. 11/004,466 is a continuation-in-part of application No. 10/454,453, filed on Jun. 3, 2003, now Pat. No. 6,871,761.

(51) Int. Cl. B67D 5/56

(52) U.S. Cl. 222/129.1

(57) ABSTRACT

A post-mix beverage dispenser includes a jet, in fluid communication with a source of diluent, extending into a mixing chamber of the dispenser. The jet includes an aperture, typically in a sidewall thereof, configured to spray the diluent. A diffuser is disposed below the jet. The concentrate is emitted into the mixing chamber. The diluent and concentrate collide in the mixing chamber to create a frothed beverage.

### BACKGROUND OF THE INVENTION

The present invention generally relates to beverage dispensers. More particularly, the present invention relates to a post-mix beverage dispenser for whipped beverages.

There are presently a number of popular beverages sold in restaurants, snack shops, amusement parks, fast food outlets, and other establishments throughout the world. Some of these beverages are served in a whipped or foamed condition. That is, the beverage is agitated or whipped in the dispensing process to give the served beverage a foamy texture. Typically, these beverages are made from a combination of a concentrate and a diluent, usually water. The concentrate by itself generally does not require refrigeration and has a shelf life of several months to over a year.

For years, two basic types of fountain dispensers have been available to the trade, referred to respectively as “pre-mix” and “post-mix” dispensers.

Pre-mix dispensers require syrup concentrate and water to be pre-mixed to provide a finished beverage which is then stored in a holding tank until dispensed through a faucet located on the dispenser. However, such pre-mix dispensers suffer from a number of disadvantages. Pre-mixing the syrup and water requires employee time and resources. Even with refrigeration, some bacterial growth is present. Consequently, after a period of time, typically a few days, any remaining pre-mix beverage should be discarded to maintain healthful quality and pleasing beverage taste. Thus, it is necessary to disassemble and clean the whipping assembly on a daily basis to remove accumulated beverage residue remaining in the dispensing apparatus.

Post-mix dispensers do not pre-mix the syrup and water, saving the manual mixing time and employee resources. Instead, the syrup and water are conveyed by separate conduits to a dispenser head, sometimes referred to as a valve, and then mixed while being dispensed through the usual spout on the housing. The syrup may be stored remotely from the dispenser housing in a metallic cylinder, or in a collapsible plastic bag in a cardboard box, or any other suitable storage medium. The water source may simply be the available municipal water line. Post-mix dispensers overcome, to a great extent, the disadvantages suffered by the pre-mix dispensers. Accordingly, the majority of soft drinks and non-carbonated beverages sold in restaurants and fast-food businesses utilize post-mix dispensers.

A conventional post-mix beverage dispenser, referred to by the reference number 10, is illustrated in FIGS. 1 and 2. The beverage dispenser illustrated in FIGS. 1 and 2 is similar to that provided by Cornelius under the UF-1 designation. Other companies provide similar post-mix beverage dispensers operating under generally the same principles and having very similar components.

Referring now to FIGS. 1 and 2, a dispenser head 12 is shown which extends from a support structure (not shown) which, as is well-known in the art that, can accommodate ice and includes fluid conduits to a source of water or other diluent and beverage concentrates, as well as typically accommodating a plurality of dispenser heads. Such support structures typically include a drain basin for collecting spilled beverage and ice, and have a grate 14 for supporting cups 16 thereon so that the cups 16 can be positioned below the dispenser head 12 to receive the beverage 18.

With particular reference to FIG. 2, the dispenser head 12 includes a cover 20, shown in phantom, which houses the necessary components and conduits for dispensing a diluent, typically water, and a syrup or concentrate. As such, the head 12 includes inlet conduits 22 which are connected to fluid lines extending to either the water source or the source of concentrate. Flow regulators 24 are used to adjust the amount of water or concentrate delivered. A switch 26, such as the illustrated push-button switch, electrically activates a solenoid 28 which creates a magnetic field causing an arm 30 to move against the bias of spring 32 and open valves to allow the water and concentrate to flow into a mixing chamber. The dispenser head 12 may include other conduits and chambers for electrical lines, concentrate and diluent passageways, motors as necessary, etc. These components are traditional and well-known in the art.

A generally cylindrical wall 36 extends downwardly from a bottom portion of the dispenser head 12. The spout 34 is attached to the head 12 by a twist-turn frictional fit so that it is removably attached to the head 12 for cleaning purposes and the like. The spout 34 may include a protrusion 38 which is inserted bayonet-style into a mating notch and groove (not shown) such that upon inserting and turning the spout 34 a quarter-turn, it is locked in place. Typically, the spout 34 is defined by generally cylindrical upper portion 40, which tapers at a lower portion 42 thereof to an outlet 44 through which the beverage 18 is dispensed.

In conventional soft drink dispensers, syrup concentrate and pressurized carbon dioxide mixed with water are dispensed through the dispenser head 12 such that the carbonated water falls substantially directly downwardly over a diffuser through which the syrup concentrate is emitted such that the carbonated beverage 18 mixes as the syrup and carbonated water fall through the spout 34 and into the cup 16.

With reference now to FIGS. 2-4, the diffusers 46 conventionally used typically include a hollow post 48 having an O-ring or the like 50 for insertion directly into the syrup concentrate outlet of the dispenser head 12. In one form, the diffuser 46 includes a skirt 52 having apertures 54 which extend into the hollow tube 48 such that the concentrate is ejected from the apertures 54. Grooves or canals 56 can also be implemented to direct the concentrate emitted from the apertures 54. Alternatively, as illustrated in FIG. 4, apertures 60 are formed at a closed end of the hollow tube 48.

The diffusers 46 and 58 also include two or more rings 62 and 64 having a plurality of apertures 66 formed therethrough. The skirt 52 and two or more rings 62 and 64 are of the same diameter. It is well known that when creating carbonated drinks foam is undesirable. The carbonated water tends to foam as it is released into the cup. Accordingly, prior art diffusers, such as diffusers 46 and 58, include a plurality of skirts and rings 52, 62 and 64 so as to reduce the foaming as much as possible. In fact, other prior art diffusers include three or even four rings in an attempt to reduce the foaming created by the carbonated water in the drink.

Thus, as water or other diluent is dropped from an outlet of the diluent conduit from the dispenser head into the spout 34, it cascades over the diffuser 46 or 48. In the case of the embodiment illustrated in FIG. 3, the water diluent somewhat mixes with the syrup concentrate emitted from skirt apertures 54 as it passes over the skirt 52 and apertured rings 62 and 64 and eventually through the spout 34 and into the cup 68. In the case of the embodiment illustrated in FIG. 4, the concentrate is emitted through the apertures 60 so as to somewhat mix with the water diluent as it passes through the spout. However, in either case, it has been found that the syrup concentrate and water diluent mix most substantially in the cup 16 itself. In any event, while performing adequately well for soft drinks and juice drinks, such as lemonade and the like, this design does not froth or whip the beverage. To create a frothed or whipped beverage requires turbulent mixing of the water diluent and syrup concentrate so as to entrain air bubbles therein. Moreover, the syrup concentrate must be prone to such whipping, such as Orange Bang, Inc.'s Orange Bang®, Pina Colada Bang®, and Strawberry Bang® beverages. Frothed or whipped beverages are more foaming than carbonated or non-whipped drinks and typically require a special syrup capable of being whipped.

In the early 1980's, Orange Bang, Inc. designed a dispenser 100 for a whipped beverage comprising a specially designed plastic mixing block 102, as shown in FIG. 5. The mixing block 102 included a generally hemispherically shaped mixing chamber 104 cut-out therefrom. A syrup concentrate conduit 106 was formed in the block 102 such that it extended between the mixing chamber 104 and a solenoid valve 108 which controlled the delivery of the pressurized syrup concentrate. Similarly, a conduit 110 was formed in the block 102 which was in fluid communication with the mixing chamber 104 and another solenoid valve 112 for controlling the amount of pressurized water which was delivered. The concentrate and water conduits 106 and 110 were angled with respect to one another such that the syrup and water would be ejected at angles which would intersect at a given point to create the frothed beverage. It was discovered that the mixing chamber 104 had to be vented to allow air to be introduced into the mixing chamber 104 and allow the concentrate and water to whip or froth. It was discovered that the mixing chamber 104 had to be vented to allow air to be introduced into the mixing chamber 104 and allow the concentrate and water to whip or froth. Accordingly, a vent conduit 114 was formed in the block 102. It was also found that whip-gain was improved and the possibility of the beverage entering the vent conduit 114 virtually eliminated by the addition of a metal tube 116 within the vent conduit 114 and extending into the water conduit 114. As the water cascaded over the end of the tube 116, a venturi effect was created allowing air to be drawn into the water stream, while preventing the back flow of beverage through the air vent 114 and out of the exterior of the block 102 of the dispenser 100. Other conduits 118 such as for electrical leads, stream control devices, etc. were formed in the mixing block 102.

U.S. Pat. No. 4,676,401 to Fox et al. discloses an improvement on this design, wherein a mixing paddle operated by a motor is introduced into the mixing chamber to improve the whip-gain of the whipped beverage.

U.S. Pat. No. 6,305,269 to Stratton, discloses a slight variation to the initial Orange Bang, Inc. beverage dispenser. To improve whip-gain, Stratton discloses the use of a uniquely configured water injection nozzle having a tube with a flattened end portion defining an elongated water injection port extending into the mixing chamber. Such specialized water injection nozzle provided sufficient whip-gain. However, this dispensing apparatus also required a specially designed plastic mixing block with the various passage-ways, chambers, air vents, etc.

Another problem with all of these devices is that, due to their specialized design, they effectively served as a stand-alone dispenser. This required that the establishment make room for the dispenser next to traditional carbonated beverage dispensing banks, as illustrated in FIGS. 1 and 2 and described above.

Accordingly, there is a continuing need for an apparatus which can be incorporated into a traditional bank of post-mix soft drink dispenser heads which will mix and dispense whipped beverages. Such an apparatus, or modified dispenser head, should not require the use of specialized equipment, such as plastic mixing blocks, vented chambers, motorized mixing paddles or the like. The present invention fulfills these needs, and provides other related advantages.

### SUMMARY OF THE INVENTION

The present invention resides in a post-mix beverage dispenser for whipped or frothed beverages. The beverage dispenser of the present invention does not require specialized equipment, such as plastic mixing blocks drilled or cut to have the necessary air vents, conduits and chambers formed therein, flattened tubes, or motorized mixing paddles. Instead, the dispenser preferably modifies a conventional dispensing head to accomplish the present invention.

Typically, the dispenser head includes an outlet spout attached thereto and which cooperatively define the mixing chamber. Preferably, the spout is removably attached to the head, in standard fashion, to facilitate the cleaning of the spout and the upper portion of the mixing chamber. The head includes inlet conduits fluidly connected to the sources of diluent and concentrate, and valves for controlling the flow of diluent and concentrate from the inlet conduits to the mixing chamber. A switch selectively operates the valves.

In one embodiment, a jet is in fluid communication with a source of diluent and configured to spray the diluent out over a wide area towards the wall of the mixing chamber. The jet generally comprises a body extending from the diluent outlet of the dispensing head. The body is hollow and includes an open end in fluid communication with the diluent outlet, and a generally opposite closed end. Typically, the body has a generally tubular configuration. An aperture is formed in a side wall of the body so as to emit the diluent generally transverse to the longitudinal axis of the body. Preferably, the jet aperture is of a smaller dimension than the diluent outlet so as to increase the velocity of the diluent emitted therefrom. The diluent is emitted along a path other than a longitudinal axis of the body so as to contact syrup concentrate emitted into the mixing chamber to create a fluid-foam beverage mixture. Typically, the jet includes an elongated and narrow aperture.

In the present invention, the jet is configured so as to be inserted into the diluent outlet so as to extend into the mixing chamber, defined by the dispenser head and attached spout. The jet includes an aperture configured to spray the diluent towards the wall of the mixing chamber, generally opposite the jet, and in a direction generally transverse to a longitudinal axis of the jet. Typically, the jet aperture comprises either an elongated and narrow opening or a series of generally aligned apertures formed in a side wall of the jet body to create the desired spray effect. Typically, the jet is removably inserted into the diluent outlet. Preferably, the jet includes a projection extending from the body thereof configured to facilitate positioning of the body into the diluent outlet such that the one or more jet apertures are directed towards the source of concentrate syrup.

A diffuser, having a plurality of apertures, is disposed within the spout below the jet. This enables sufficient air to be introduced into the mixing chamber, while simultaneously delivering the frothed beverage out of the spout and into the customer's cup. Typically, the diffuser includes a plate that is generally circular and of generally uniform thickness.

In another embodiment, the diffuser is generally bowl-shaped, with a lower portion having a plurality of apertures formed therein, and a generally circumferential side wall extending upwardly therefrom. Typically, the lower portion defines a generally planar plate member.

In yet another embodiment, the diffuser includes a hollow shaft having an end insertable to a concentrate dispensing outlet of the dispenser head. The plate extends outwardly from the shaft, typically at an end opposite the end of the shaft insertable into the outlet. In this embodiment, as the diffuser is fluidly connected to the concentrate dispensing outlet, the diffuser includes an outlet for emitting concentrate into the mixing chamber.

In one embodiment, the diffuser outlet comprises an aperture formed in the hollow shaft. Preferably, the aperture comprises an elongated slit.

In another embodiment, a skirt extends outwardly from the shaft, above the plate, and has a diameter less than that of the plate. The diffuser outlet is formed in the skirt, and typically includes a plurality of spaced apart apertures formed therein so as to be in fluid communication with the hollow shaft.

It has been found that the aforementioned arrangements allow the use of traditional dispensing heads which are modified only slightly to froth or whip the beverage. Furthermore, there is no need for air passageways to create venturi effects or other specialized equipment.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a partially fragmented perspective view of a conventional prior art post-mix beverage dispenser head delivering a beverage into a cup.

FIG. 2 is a partially exploded side perspective view of the beverage dispenser of FIG. 1, illustrating a cover thereof in phantom.

FIG. 3 is a perspective view of a prior art diffuser.

FIG. 4 is a bottom perspective view of another prior art diffuser.

FIG. 5 is a partially sectioned perspective view of a prior art specialized mixing block and dispenser apparatus.

FIG. 6 is a partially fragmented and exploded view of a jet and diffusers embodying the present invention and incorporated into a conventional post-mix beverage dispenser head, in accordance with the present invention.

FIG. 7 is a front perspective view of a jet used in accordance with the present invention.

FIG. 8 is a front perspective view of another jet used in accordance with the present invention.

FIG. 9 is a cross-sectional view taken generally along line 9-9 of FIG. 1, but incorporating the jet and diffuser of the present invention so as to create a frothed beverage.

FIG. 10 is a top plan section view taken along line 10-10 of FIG. 9, illustrating the flow of diluent and concentrate in a mixing chamber of the dispenser, in accordance with the present invention.

FIG. 11 is a front perspective view of another diffuser embodying the present invention.

FIG. 12 is a cross-sectional view taken generally along line 12-12 of FIG. 11.

FIG. 13 is a front perspective view of another diffuser embodying the present invention.

FIG. 14 is a bottom perspective view of the diffuser of FIG. 13.

FIG. 15 is a cross-sectional view taken generally along line 16-15 of FIG. 13.

FIG. 16 is a diagrammatic view illustrating the paths taken by diluent and concentrate, using the diffuser of FIG. 13, in accordance with the present invention.

FIG. 17 is a front perspective view of another diffuser embodying the present invention.

FIG. 18 is a cross-sectional view taken generally along line 18-18 of FIG. 17.

FIG. 19 is a partially sectioned perspective view taken generally along line 19-19 of FIG. 6, illustrating a jet embodying the present invention inserted into a diluent outlet of the head, and a concentrate syrup outlet of the head.

FIG. 20 is a partially exploded perspective view, similar to FIG. 19, illustrating the jet removed from the diluent outlet.

FIG. 21 is a partially sectioned and exploded view illustrating diffusers insertable into a spout, and the jet insertable into the diluent outlet of the dispenser head.

FIG. 22 is a cross-sectional view illustrating the components of FIG. 21 in an assembled state.

FIG. 23 is a cross-sectional diagrammatic view illustrating diluent being emitted by the jet and into contact with concentrate syrup to create a whipped beverage, in accordance with the present invention.

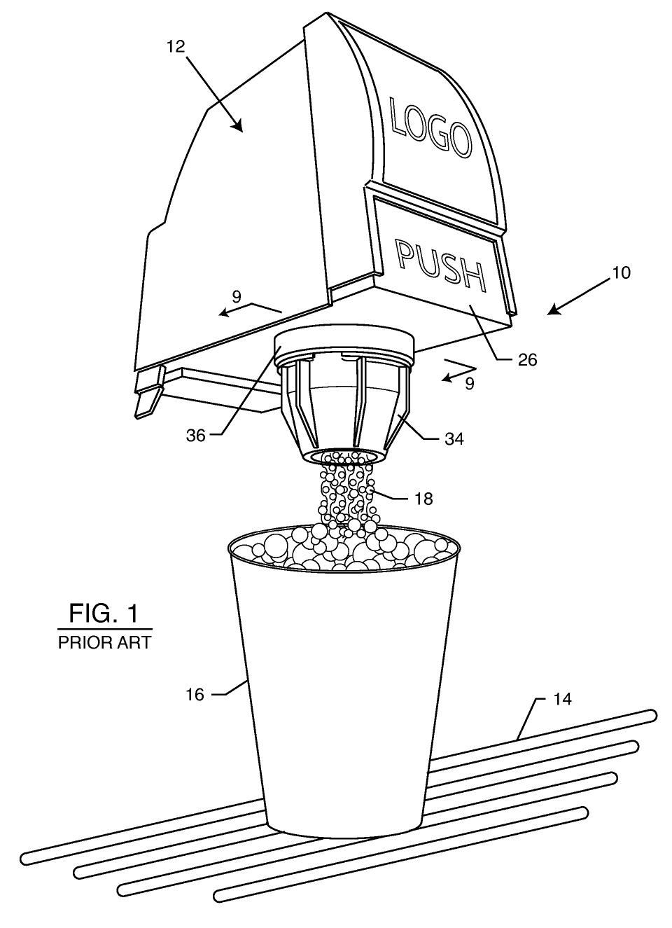

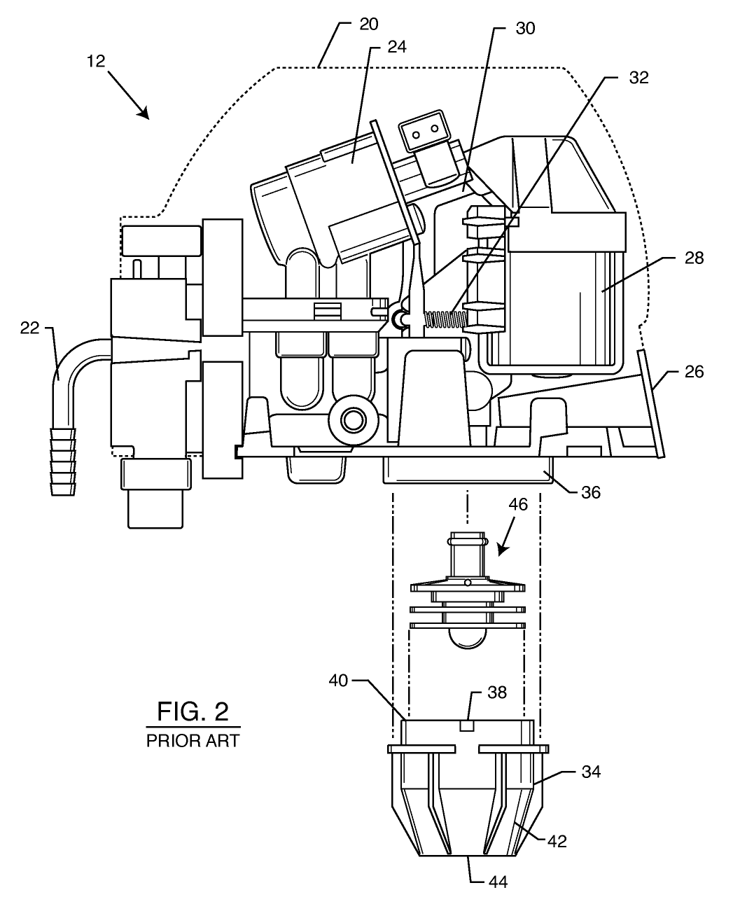

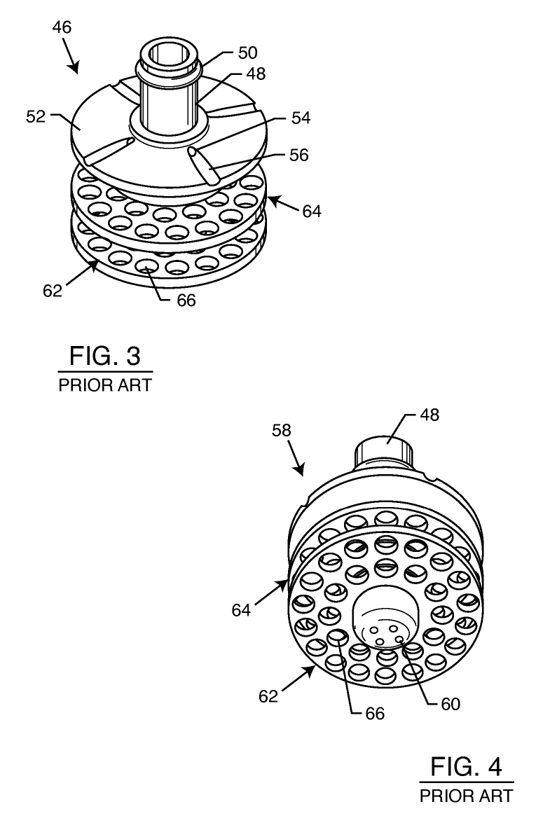

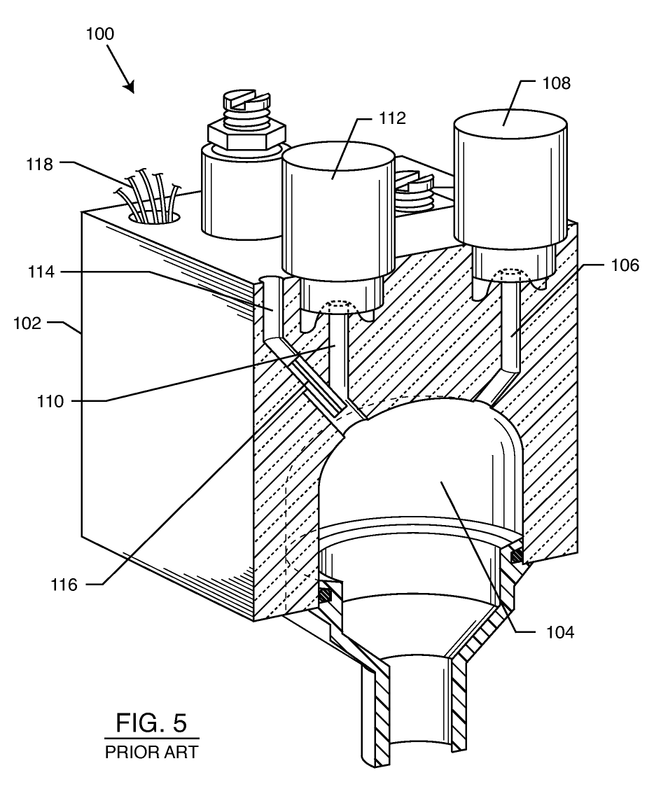

### DETAILED DESCRIPTION OF THE PREFERRED EMBODIMENTS

As shown in the accompanying drawings for purposes of illustration, the present invention resides in a post-mix beverage dispenser, which adds new and modified components to conventional beverage dispenser heads to create a frothed beverage in accordance with the present invention.

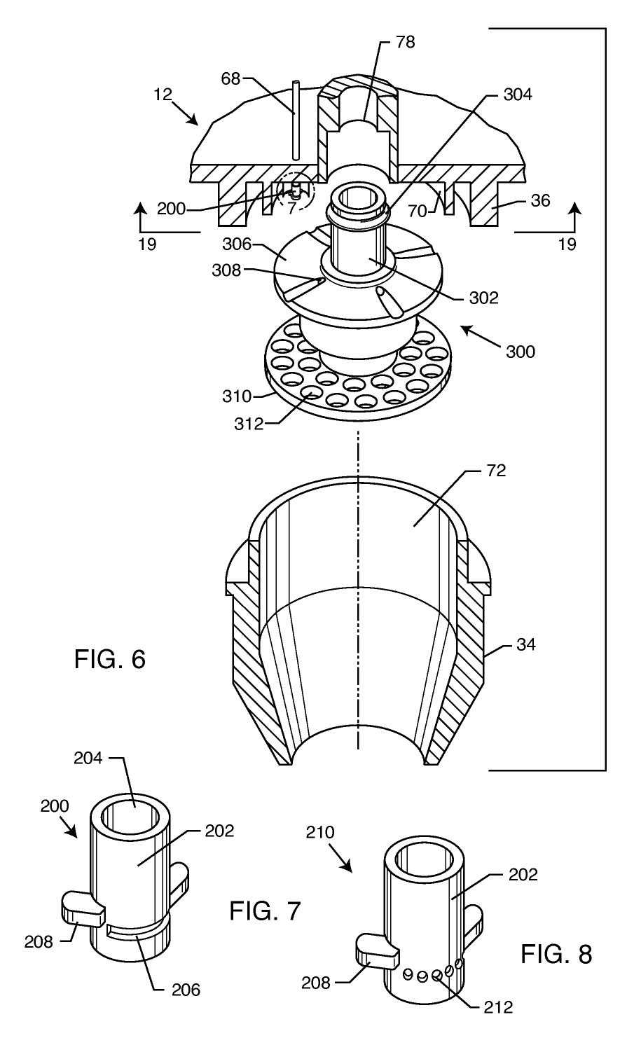

It was found by the inventor that if various modifications were made to the conventional dispenser 10, a frothed drink could be created with the appropriate syrup. The first necessary addition, referring to FIG. 6, was the inclusion of a jet member 200 which was inserted into the diluent conduit 68 outlet. Thus, instead of dropping the water diluent downwardly, the water diluent could be directed towards an inner-surface 70 of the outer wall 36 and an inner-surface 72 of the upper portion of the spout 34. These inner surfaces 70 and 72 or what is referred to herein as the “mixing chamber”.

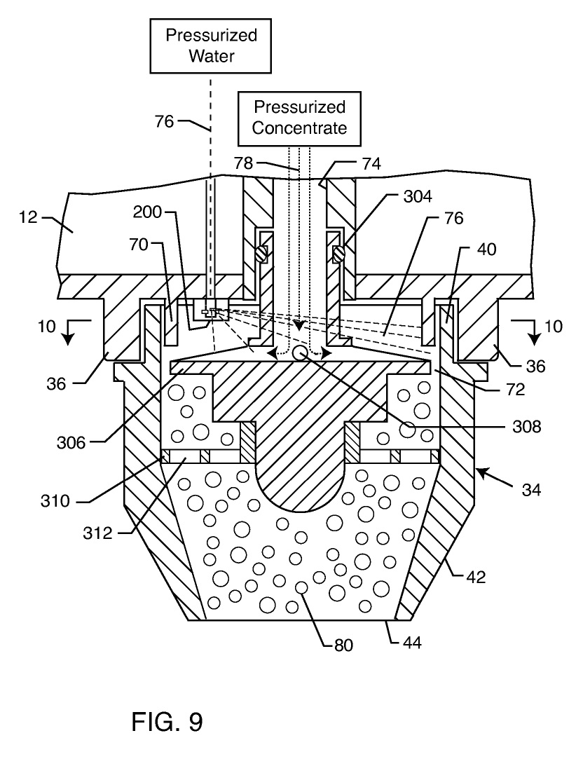

The water jet 200 includes a closed-end generally tubular member 202 having an opening or inlet 204 in fluid communication with the diluent conduit 68. An elongated and narrow aperture 206 is formed in a lower portion of the tubing 202 such that a pressurized stream of water diluent is sprayed from the water jet 200 and into the mixing chamber so as to hit the wall surfaces 70 and 72, as illustrated in FIG. 9, and as will be described more fully herein. Projections 208 preferably extend from the tube 202 so as to facilitate orientation of the water jet 200 into the outlet of the diluent conduit 68, and also so as to ensure that the water jet 200 is not inserted too deeply into the water conduit 68 such that the aperture 206 extends into the mixing chamber.

With reference to FIG. 8, another water jet 210 is illustrated wherein instead of a single elongated and narrow aperture 206, a plurality of apertures 212 are formed in a generally aligned fashion as illustrated. Similarly, the elongated and narrow aperture 206 of FIG. 7 could have one or more cross-beams or barriers so as to create multiple slits. The important aspect of the present invention is that the jet 200 include an aperture configured such so as to spray the diluent over a wide angle and preferably with a relatively high velocity onto the surfaces 70 and 72 of the mixing chamber. As such, the diluent is typically sprayed in a generally arched pattern so as to contact as much of the inner surfaces 70 and 72 as possible. Of course, it will be appreciated by those skilled in the art that as few as a single aperture can be formed in the body member 202 so as to create a whipped drink, although the whipping gain or amount of whipped beverage to non-whipped beverage may be lessened.

Referring again to FIG. 6, it was found that even with the installed jet 200, the design of the prior art diffusers 46 and 58 prevented the proper whipping or frothing of the beverage. Accordingly, the inventor created a new diffuser 300 having a hollow post 302 adapted to be inserted into the outlet 74 of the concentrate conduit of the dispenser head 12. Preferably, the hollow tube 302 includes a sealing means, such as the illustrated O-ring 304. This ensures a tight and leak-free fit with a dispenser head 12. It was found that if the skirt 306 was reduced in diameter, whipping gain was improved. In the embodiment illustrated in FIG. 6, the diffuser outlets 308 are formed through the skirt 306 and into the hollow tube 302 so as to emit the concentrate therethrough and towards the inner surfaces 70 and 72, as will be more fully discussed herein.

It was also found that a single ring or plate 310 having a plurality of apertures 312 formed therethrough enables the beverage to become frothy and whipped. Thus, the additional plates or rings were removed as these interfered with the whipping process. The plate 310, as illustrated in FIG. 6, is of greater diameter than the skirt 306, generally planar and typically circular so as to fit within the spout 34.

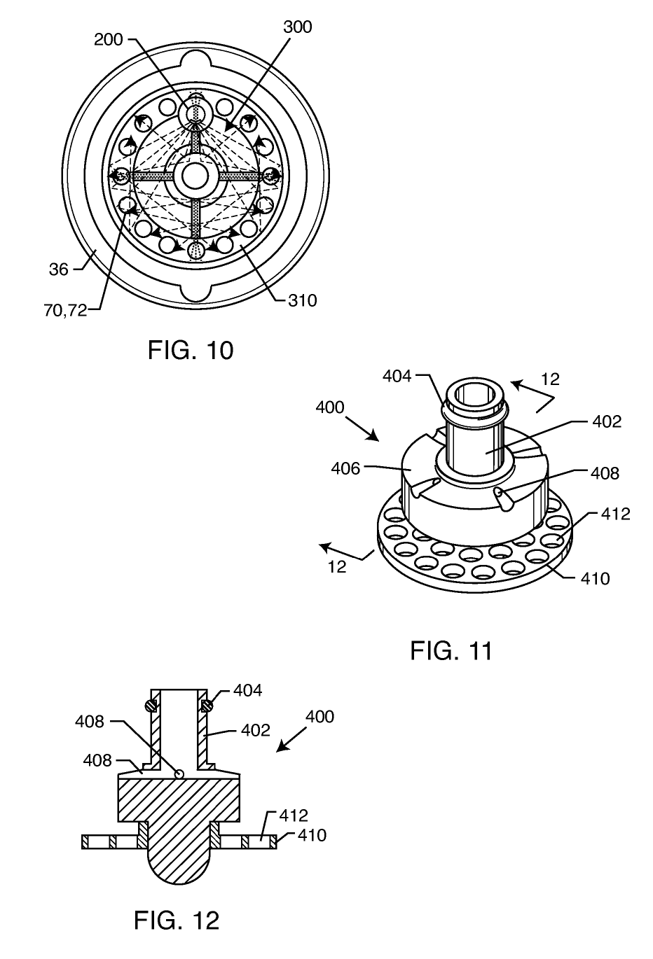

With reference now to FIGS. 9 and 10, with the water jet 200 inserted into the outlet of the diluent conduit 68 and the diffuser 300 properly inserted in the concentrate outlet 74, the diluent 76 is sprayed outwardly generally towards the walls or inner surfaces 70 or 72 of the mixing chamber, and also hits the exposed surfaces of the diffuser 300. As illustrated in FIG. 10, the spray forms a generally arcuate pattern so as to expand outwardly away from the water jet 200 and thus hit a large surface area of the surfaces 70 and 72. Simultaneously, the concentrate 78, illustrated by the dotted line, is ejected out of the spaced-apart outlet 308 of the skirt 306. The result is that the sprayed water diluent 76 and concentrate 78 collide with one another either mid-stream or after colliding with the inner surface walls 70 and 72 of the mixing chamber. The diluent and concentrate 76 and 78 collide with sufficient force and turbulent nature so as to entrain air bubbles therein and create a frothed beverage 80 which falls through the apertured plated ring 310 and out the outlet 44 of the spout 34. Thus, by inserting the waterjet 200 and modified diffuser 300, a whipped and frothed beverage can be created using conventional dispensers 10. It should be noted that the orientation of the syrup concentrate outlet does not matter as a frothed beverage is created regardless.

With reference now to FIGS. 11 and 12, another diffuser 400 is illustrated which is similar to that illustrated in FIG. 6. The diffuser 400 also includes a hollow tube 402 with an O-ring seal 404 or the like, as well as a skirt 406 having a plurality of outlets 408, typically spaced apart from one another and in fluid communication with hollow tube 402 so as to emit concentrate therefrom. However, in this case, the skirt 406 is of further reduced diameter with respect to the bottom plate 410, as compared to the skirt 306 of FIG. 6. It has been found that reducing the diameter of the skirt 406 increases the “gain” or whipping of the beverage, thus requiring less concentrate.

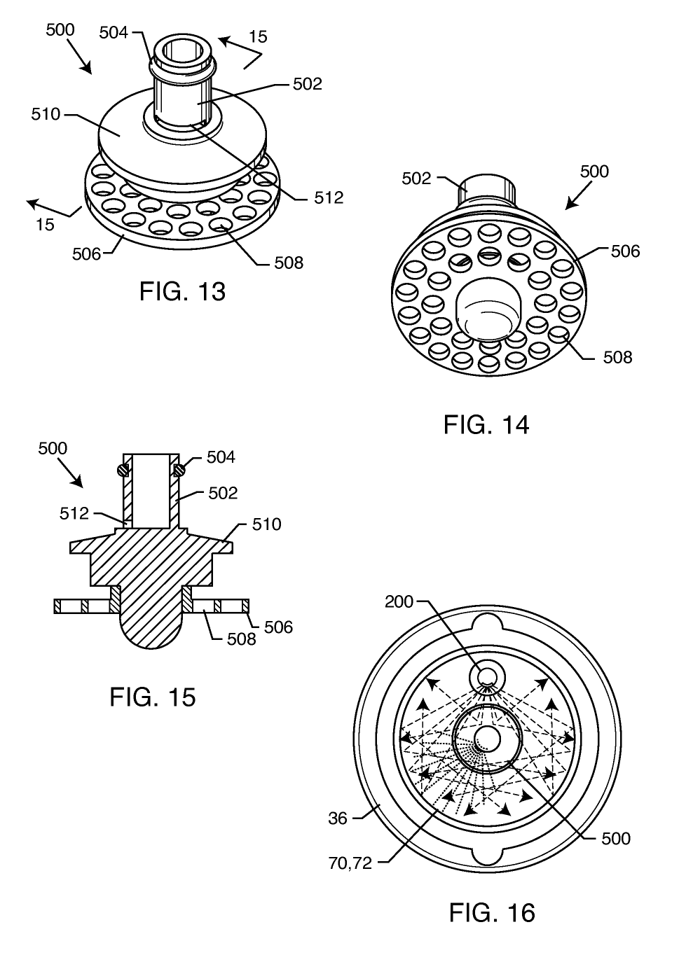

With reference now to FIGS. 13-16, yet another diffuser 500 is illustrated. This diffuser, also includes a hollow tube 502 in fluid communication with the concentrate outlet such that concentrate flows therethrough and a seal 504, such as the illustrated O-ring. This diffuser 500 also includes a lower ring or plate 506 having a plurality of apertures 508 formed therein, as discussed above. The diffuser 500 also includes a skirt 510 of reduced diameter as compared to the ring 506. However, in this case, the diffuser outlets are not formed in the skirt 510. Instead, an elongated aperture in the form of a slit 512 is formed directly in the hollow tube 502.

With particular reference to FIG. 16, the jet 200 is installed in the diluent outlet 68, as described above, and sprays diluent (shown by the dashed lines) outwardly, so as to hit the inner surfaces 70 and 72 of the mixing chamber in a violent and turbulent manner. It has been found that incorporating the elongated aperture 512 into the hollow tube 502 creates an arcuate spray of concentrate 78 (illustrated by the dotted lines in FIG. 16) that along its path collides with streams of diluent and also impact a portion of the inner surfaces 70 and 72. The benefit of incorporating the slit or elongated aperture 512 is that the aperture 512 need not be oriented towards the jet 200 whatsoever. A sufficient whipping gain is obtained regardless, and in fact the whipping gain is actually improved as compared to the embodiments illustrated in FIGS. 6 and 11, wherein the outlets extend from the skirt. It is believed that this is due to the “spray” effect of the elongated slit 512.

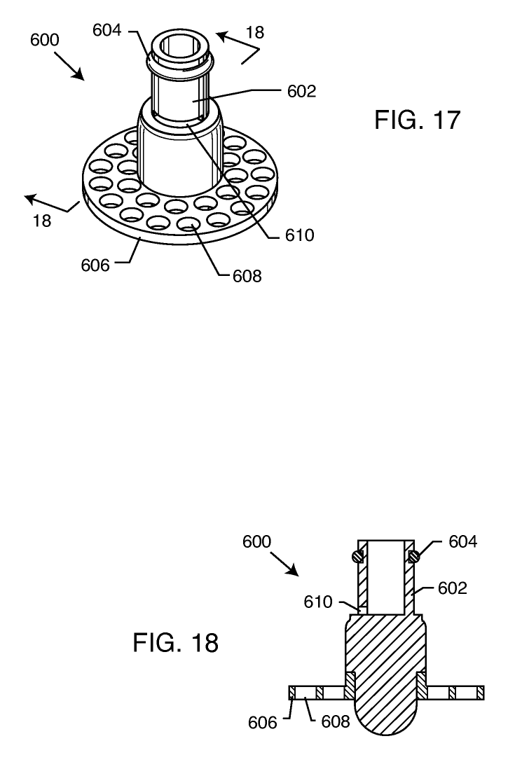

With reference now to FIGS. 17 and 18, yet another diffuser 600 embodying the present invention is illustrated. Similar to that above, the diffuser 600 includes a hollow tube 602 in fluid communication with the concentrate outlet 74 and having an O-ring 604 or the like to secure the connection and provide a leak-proof seal. A lower plate 606 extends outwardly and has a plurality of apertures 608 formed therein such that the frothed drink 80 can fall therethrough. In this case, however, the skirt is significantly reduced so as to be virtually non-existent. It has been found that the skirt is actually not necessary, particularly when the elongated aperture or slit 610 is formed in the hollow post 603.

The method of mixing is similar to that illustrated and described with respect to FIG. 16. Of particular advantage of the present invention is that the jet 200 can be installed so as to extend into the mixing chamber and the slit 206 or aperture 212 thereof directed into the mixing chamber. As the diffuser and spout are typically removed each night for cleaning, when they are reconnected to the dispenser head 12, the diffuser 300, 400, 500 or 600 can be installed in any orientation and a frothed drink still created.

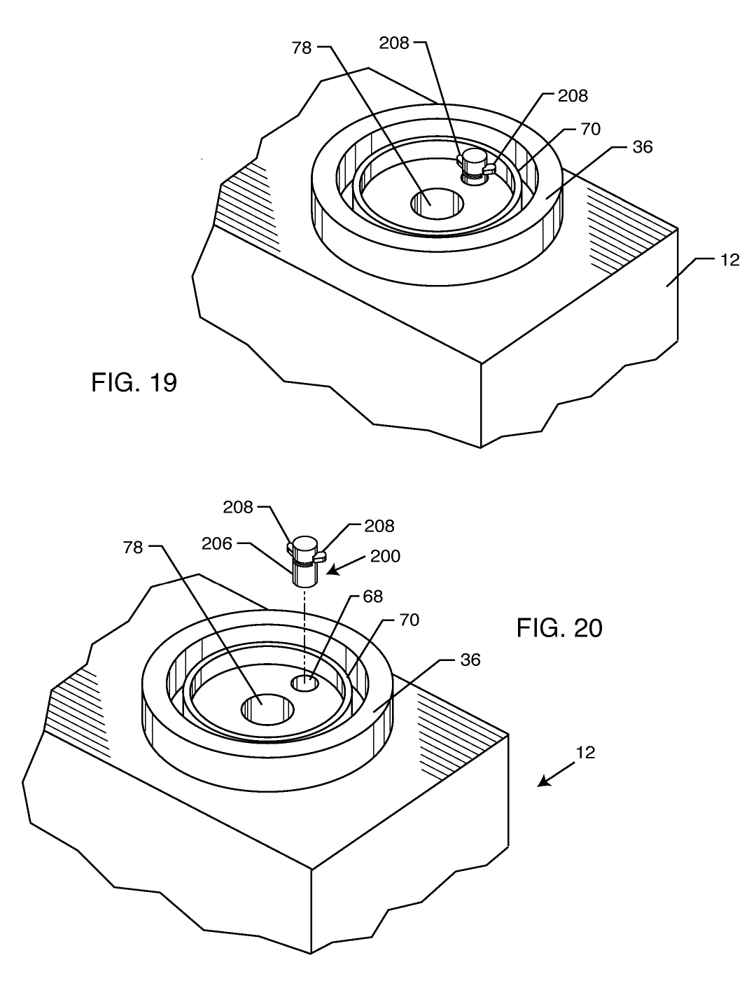

With reference now to FIGS. 19 and 20, as described above, the jet 200 is disposed within the diluent outlet 68 of the dispenser head 12. In FIGS. 19 and 20, the dispensing head 12 is illustrated upside down for purposes of illustration. As discussed above, the jet 200 includes a generally tubular body portion 202 having an open 204 at one end thereof for fluid communication with the diluent outlets 68, a closed end, and at least one aperture 206 formed in the tubular body 202 so as to emit diluent at an angle other than the longitudinal axis of the tubular body 202, and most typically transverse to the longitudinal axis of the jet 200. The one or more projections 208 come into contact with an inner wall 70 of the dispenser head 12 so as to orient the aperture 206 of the jet towards the syrup concentrate outlet 78. Moreover, the projections 208 prevent the jet 200 from being inserted into the diluent outlet 68 too far, which might occlude the jet aperture 206.

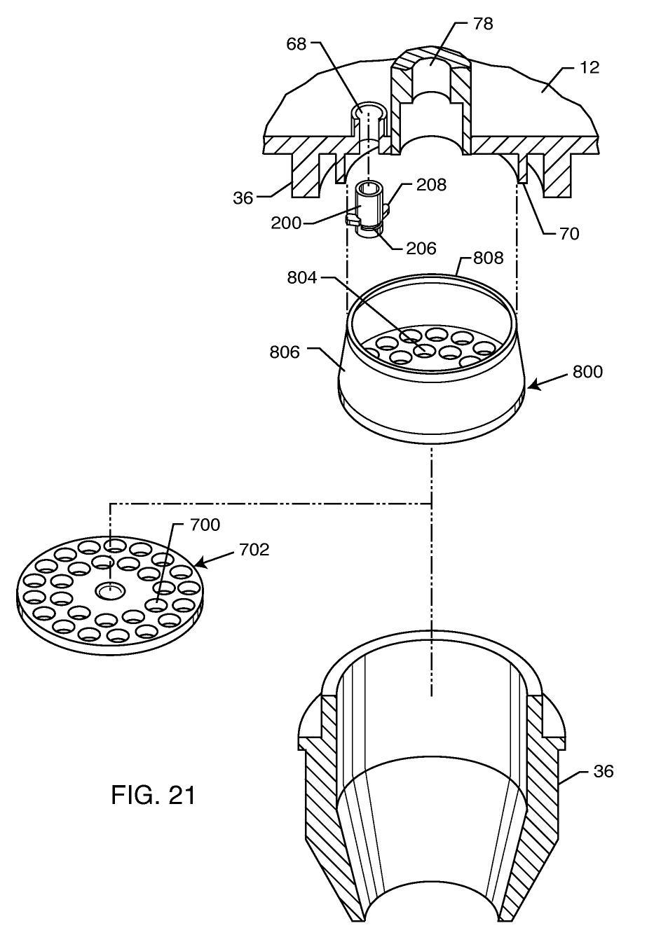

With reference to FIG. 21, it has been found that a single plate 700 having a plurality of apertures 702 can alone act as the diffuser. In this case, the plate diffuser 700 would be inserted, or otherwise disposed, in the spout 34. The syrup concentrate would exit the outlet 78 of the dispenser head 12. The diluent, typically water, would be emitted from the jet 200 such that the diluent is sprayed in a horizontal direction or a direction generally transverse to the longitudinal access of the body 202 of the jet 200 so as to contact the stream of concentrate exiting from the concentrate outlet 78. This violent collision, due to the high velocity of the diluent emitted from the jet 200, creates turbulence and entrains air in the syrup and water mixture. As discussed above, the diluent is typically non-carbonated and the syrup concentrate is of the appropriate composition so as to be capable of being whipped or frothed.

Due to the multiple apertures 702 in the diffuser plate 700, the frothed beverage is allowed to exit through some of the apertures 702, while air is allowed to enter into the mixing chamber through other apertures 702. In the present invention, the presence of the diffuser controls the flow of the beverage product from the outlet spout 44 by reducing or eliminating splashing which would occur without the presence of the diffuser. Moreover, the diffuser serves to retain the beverage above it for a sufficiently long enough time that the syrup concentrate and water can adequate mix with one another, and air bubbles are entrained within the mixture creating the whipped beverage which then flows through the diffuser and out the outlet spout 44 into the customer's cup.

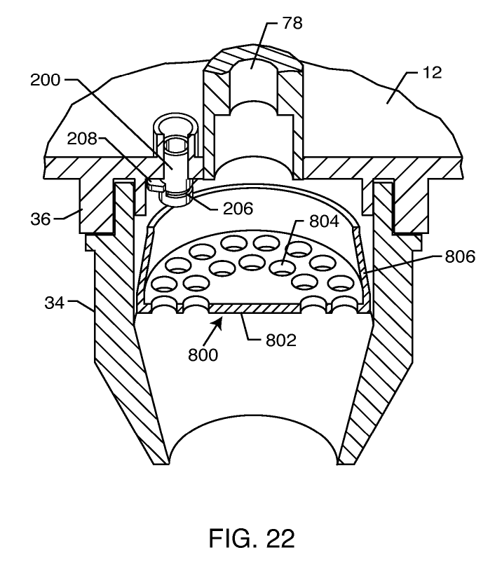

In fact, it has been found that a diffuser having a plurality of apertures so as to permit the beverage to fall therethrough and air to pass upwardly into the mixing chamber will create a froth and whipped beverage when used in connection with the jet 200. This is due to the fact that the diffuser permits the sprayed water and concentrate to violently mix with one another and air bubbles to become entrained therein before falling through some of the apertures in the diffuser and out the outlet spout 44. FIG. 21 illustrates another diffuser 800 having a generally bowl-shaped configuration. That is, the diffuser 800 includes a generally planar bottom portion or plate 802 having a plurality of apertures 804 formed therein. A circumferential wall 806 extends upwardly therefrom, with a top ledge thereof 808 being disposed below the jet 200 in the assembled state, as illustrated in FIG. 22. In actuality, the jet 200 is inserted into the diluent outlet 68 of the dispenser head 12. The diffuser 700 or 800 is inserted into the spout 34, which is then frictionally fit to the dispensing head 12, as discussed above.

The insertion of the bowl-shaped diffuser or the disk diffuser 800 or the plate diffuser 700 into the spout is much easier for the operator of the beverage dispenser to clean and assemble as one does not have to find the syrup outlet and align the stem of the prior embodiment diffuser 300-600 into it. Moreover, the diffusers are less expensive to produce as they are more simple in nature and do not require O-rings or the like.

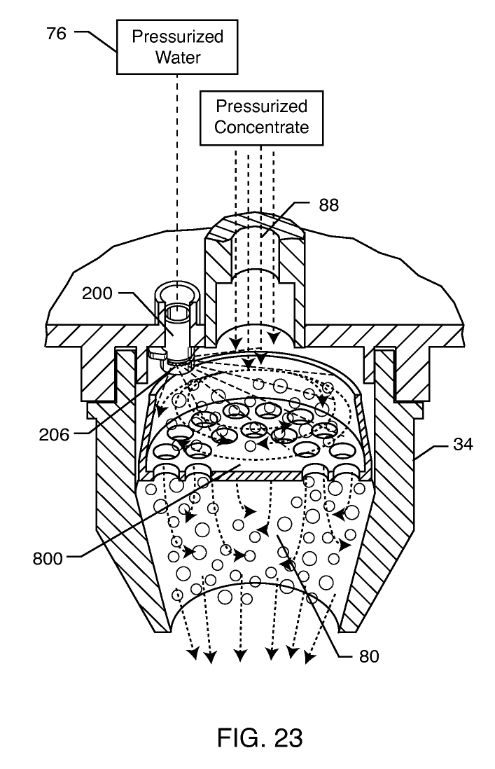

With reference now to FIG. 23, during operation, diluent, typically pressurized water, is emitted through the diluent conduit and outlet 68 and into the jet 200. The jet aperture 206 is typically of a smaller dimension than the diluent outlet 68, thus increasing the velocity of the emitted water (shown by the generally angled and horizontal dashed lines in FIG. 23). Simultaneously, at approximately the same time, the syrup concentrate is emitted through the concentrate outlet 78 so as to cascade downwardly and come into contact with the water spray. The syrup concentrate and the water collide violently to mix with one another. Additional mixing may occur due to the water bouncing off of the internal surfaces of the mixing chamber and coming into contact with the concentrate before the mixture falls through the diffuser outlet apertures 702 or 804. The result is a whipped beverage 80 having air bubbles entrained therein.

It will be appreciated by those skilled in the art that the above-described invention enables the creation of frothed drinks in conventional dispensing equipment 10, so as to eliminate the need for specialized dispensers having plastic blocks with vent tubes, paddles, etc., therein. Thus, the end user need not provide the specialized equipment in addition to the conventional dispensing equipment. Instead, the frothed beverage of the present invention can be created in the conventional manner by supplying a bag in a box, for example, connected to the dispenser's concentrate conduit 74. With the addition of the jet 200 and diffusers 300-800, a whipped drink with sufficient gain or froth is created within a single head 12 of the dispenser bank. Similar to traditional dispenser heads 12, to clean the dispenser 10, one merely needs to remove the spout 34 and diffuser 300-800, which can be washed separately, and wipe the bottom portion of the head 12 with a wash cloth or the like.

Although several embodiments have been described in detail for purposes of illustration, various modifications may be made without departing from the scope and spirit of the invention. Accordingly, the invention is not to be limited, except as by the appended claims.

What is claimed is:

1. A jet for a post-mix beverage dispenser comprising:
a dispensing head including conduits fluidly connected to sources of diluent and syrup concentrate, and valves for controlling the flow of the diluent and the syrup concentrate from diluent and syrup concentrate outlets;
a spout attachable to the dispensing head to define a mixing chamber;
a jet having a body extending from the diluent outlet and into the mixing chamber, the jet including an aperture formed in the body thereof so as to emit the diluent along a path other than a longitudinal axis of the body so as to contact syrup concentrate emitted into the mixing chamber to create a fluid-foam beverage mixture.

2. The dispenser of claim 1, wherein the jet is configured to be removably inserted into the diluent outlet.

3. The dispenser of claim 1, wherein the body is hollow and includes an open end in fluid communication with the diluent outlet and a generally opposite closed end.

4. The dispenser of claim 3, wherein the body has a generally tubular configuration.

5. The dispenser of claim 1, wherein the jet aperture is formed in a side wall of the body so as to emit the diluent generally transverse to the longitudinal axis of the body.

6. The dispenser of claim 1, wherein the jet aperture is of a smaller dimension than the diluent outlet so as to increase the velocity of the diluent emitted therefrom.

7. The dispenser of claim 1, wherein the jet aperture comprises an elongated and narrow aperture.

8. The dispenser of claim 1, wherein the jet aperture comprises a series of generally aligned apertures.

9. The dispenser of claim 1, including a projection extending from the body configured to facilitate positioning of the jet into the diluent outlet.

10. The dispenser of claim 9, wherein the projection comprises multiple projections extending outwardly from an upper portion of the body in angular spaced relation.

11. The dispenser of claim 9, wherein the projections are configured to engage a portion of the dispensing head to orient the jet aperture towards the emitted stream of concentrate.

12. The dispenser of claim 1, including a diffuser disposed below the jet and having a plurality of apertures therein.

13. The dispenser of claim 12, wherein the diffuser includes a hollow shaft having an open end insertable into the concentrate outlet, a generally opposite closed end, and defining a concentrate outlet disposed above the apertured plate.

14. The dispenser of claim 12, wherein the diffuser comprises a plate having a plurality of apertures formed therein.

15. The dispenser of claim 14, wherein the plate is removably insertable into the spout below the jet.

16. The dispenser of claim 12, wherein the diffuser includes a lower apertured portion and a circumferential wall extending upwardly from the lower portion.

17. The dispenser of claim 16, wherein the diffuser is removably insertable into the spout below the jet.

18 A jet for a post-mix beverage dispenser having an outlet spout attached to a dispensing head and defining a mixing chamber, the dispensing head including conduits fluidly connected to sources of diluent and syrup concentrate, and valves for controlling the flow of diluent and concentrate from outlets of the conduits, the jet comprising:
a hollow body having an open end inserted into the diluent outlet and a generally opposite closed end extending into the mixing chamber, and an aperture formed in a side wall of the body so as to emit the diluent into contact with the syrup concentrate emitted into the mixing chamber to create a fluid-foam beverage mixture.

19. The jet of claim 18, wherein the body is configured to be removably inserted into the diluent outlet.

20. The jet of claim 18, wherein the jet aperture comprises an elongated and narrow aperture.

21. The jet of claim 18, including a projection extending from the body configured to facilitate positioning of the body into the diluent outlet.

22. The jet of claim 18, including a diffuser disposed below the jet and having a plurality of apertures therein.

23 A post-mix beverage dispenser comprising:
an outlet spout attached to a dispensing head and defining a mixing chamber, the dispensing head including conduits fluidly connected to sources of diluent and syrup concentrate, and valves for controlling the flow of diluent and concentrate from outlets of the conduits;
a jet comprising: a generally tubular body having an open end removably insertable into the diluent outlet and a generally opposite closed end extending into the mixing chamber;
a projection extending from the body configured to facilitate positioning of the body into the diluent outlet; and
an elongated aperture formed in a side wall of the body and having a smaller dimension than that of the diluent outlet so as to emit the diluent generally transverse to a longitudinal axis of the body such that the diluent contacts syrup concentrate emitted into the mixing chamber to create a fluid-foam beverage mixture; and
a diffuser having a plurality of apertures formed therein disposed below the jet.

24. The dispenser of claim 23, wherein the projection comprises multiple projections extending outwardly from an upper portion of the body in angular spaced relation.

25. The dispenser of claim 23, including a diffuser disposed below the jet and having a plurality of apertures therein.

26. The dispenser of claim 25, wherein the diffuser includes a hollow shaft having an open end insertable into the concentrate outlet, a generally opposite closed end, and defining a concentrate outlet disposed above the apertured plate.

27. The dispenser of claim 25, wherein the diffuser comprises a plate having a plurality of apertures formed therein, and wherein the diffuser is removably insertable into the spout below the jet.

28. The dispenser of claim 25, wherein the diffuser includes a lower apertured portion and a circumferential wall extending upwardly from the lower portion, and wherein the diffuser is removably insertable into the spout below the jet.
